(19) United States
(12) Patent Application Publication
(10) Pub. No.: US 2014/0280937 A1
(43) Pub. Date: Sep. 18, 2014

(54) METHOD AND APPARATUS FOR DETERMINING PUBLIC SAFETY PRIORITY ON A BROADBAND NETWORK

(71) Applicant: MOTOROLA SOLUTIONS, INC., Schaumburg, IL (US)

(72) Inventors: TRENT J. MILLER, WEST CHICAGO, IL (US); PAULA TJANDRA, INVERNESS, IL (US); KAREN M. UPP, BARTLETT, IL (US)

(73) Assignee: MOTOROLA SOLUTIONS, INC., Schaumburg, IL (US)

(21) Appl. No.: 13/836,943

(22) Filed: Mar. 15, 2013

(51) Int. Cl. H04L 12/24

(52) U.S. Cl. CPC H04L 41/50
USPC 709/225

(57) ABSTRACT

A network component in a broadband network receives dynamic status information associated with a user accessing the broadband network with a first user equipment. The network component also retrieves stored priority attributes associated with the user and identifies whether another user equipment is associated with the user. The network component determines access network policy for all user equipment associated with the user by using the dynamic status information and the stored priority attributes, associates the access network policy with each user equipment associated with the user; and forwards the access network policy to a policy component. The access network policy is used in determining priority and quality of service policy for each user equipment associated with the user.

### FIELD OF THE DISCLOSURE

The present disclosure relates generally to determining public safety priority on a broadband network, and more particularly to, consistently applying user-based priority and quality of service (QoS) policy to all sessions and applications on each device associated with a given user.

### BACKGROUND

Land mobile radio (LMR) systems are typically narrowband communications systems used by public safety agencies, for example, emergency first responder organizations, such as police or fire departments, or public works organizations. Users (also referred to as subscribers) on LMR systems may communicate via mobile or portable user terminals, such as mobile telephones, smart phones, portable radios or radios on vehicles (herein collectively referred to as “user equipment” or “UE”). Different LMR systems in a jurisdiction may use different spectrum. For example, the LMR systems for police departments in a county may operate on one spectrum, while the LMR systems for fire departments in the same county may operate on a different spectrum. In addition, LMR systems may dedicate some resources for certain applications. For example, there may be dedicated resources for push-to-talk applications and dedicated resources for data services like text messaging.

A portion of the broadband spectrum, i.e., the 700 MHz spectrum, has been allocated for public safety use, wherein all public safety agencies and all applications used by these public safety agencies are expected to share this portion of the broadband spectrum. In addition, user equipment operated by secondary users (for example, utility or government workers) and/or commercial users may also share this portion of the broadband spectrum. This creates a challenge in determining the appropriate priority for user equipment operating on this portion of the broadband spectrum. For example, if the same resources are needed by user equipment operated by a police officer and user equipment operated by an emergency medical services (EMS) worker, a determination must be made as to which user equipment is given a higher priority for resource allocation.

Long Term Evolution (LTE) is a broadband standard for wireless data communications. An LTE system includes, among other components, a core network for handling data traffic and a network of eNodeBs (eNBs), each of which functions as a base station for the LTE system and forwards user data and signaling between the core network and user equipment operating on the LTE system. The core network includes a Policy and Charging Rules Function (PCRF) that aggregates information in real-time to manage service policy and provide quality of service (QoS) setting information for each user equipment's unicast sessions. While the standards are still maturing, it is envisioned that a function similar to the PCRF will aggregate information in real-time to manage Multimedia Broadcast Multicast Service (MBMS) session policy and QoS. MBMS provides point-to-multipoint downlink (i.e., core network to user equipment) capabilities, such that information can be transmitted by an eNB and would be received by two or more UEs simultaneously. Nevertheless, the LTE standards do not include priority attributes (such as, roles, incidents, and emergency attributes) that may be used in prioritizing usage of public safety unicast and MBMS resources.

Based on the LTE standards, the rules that govern priority and QoS policies are typically associated with the user equipment, rather than with the user. Consider an example where, by default, a chief of police should be assigned a higher priority than a sanitation worker, regardless of the number or types of user equipments being used by either the chief of police or the sanitation worker. Both the chief of police and the sanitation worker may use, for example, a laptop and a phone, to access the LTE network. Because the policies that govern priority are typically associated with the user equipment, rather than with the user, the policies that govern priority and QoS for the chief of police and the sanitation worker will be associated with the laptop and the phone being operated by the chief of police and the sanitation worker. When multiple agencies (for example, a police department and a sanitation department) are operating on the portion of broadband spectrum allocated for public safety use, the current LTE standards provide no way for a single network operator to enable user-based (rather than device-based) public safety priority and QoS policies consistently across the multiple agencies, where the network operator controls the policy assignments. So if, for example, an emergency indication is sent from the phone operated by the chief of police, the priority for the phone operated by the chief of police may be elevated but the priority of the laptop operated by the chief of police may not be elevated. If an application being executed on the laptop operated by the sanitation worker has a higher priority than an application being executed on the laptop operated by the chief of police, this could lead to a situation where the laptop being used by the sanitation is assigned a higher priority and QoS policy than the laptop being used by the chief of police.

In LTE, the user equipments can connect to different IP networks simultaneously while sharing a single radio frequency link. Each IP network may contain a set applications needed by the user equipments. For example, the user equipments can simultaneously connect to both a national IP network and a local IP network. When a user equipment requests a data connection to an IP network, the user equipment usually provides an LTE Access Point Name (APN) which includes a network identifier that identifies the network to which the user equipment requests connectivity and an operator identifier. Therefore, one user equipment can have more than one Internet Protocol (IP)-Connectivity Access Network (IP-CAN) session, one for each APN the user equipment connects to (the IP-CAN session is also referred to as an IP connectivity session). The LTE standards provide no avenue for an application, being accessed by the user via a first IP-CAN session, to impact the priority and QoS policies of other applications being accessed by the same user using a second IP-CAN session. Consider an example where an emergency worker using a broadband network pushes an emergency button on a mobile phone connected to a first IP network. This is likely to elevate the priority for application(s) being accessed by the emergency worker on the first IP network but will not affect the priority of applications being used by the same emergency worker on other IP networks. In addition, there is no way for input from an external application or system, for example, a computer-aided dispatch (CAD) system, to impact the priority and QoS policy for call flows directed to two user equipments on different IP-CAN sessions (for example, a video device and a portable device) associated with a single subscriber.

For each APN, the current LTE standards allows for one Rx interface for a given user equipment. The Rx interface is used to exchange policy and charging related information for unicast sessions. Therefore, there is no avenue in the current LTE standards for an agency to have separate Rx interfaces based on the types of application(s) being executed on the user equipment. For example, there is no avenue in the current LTE standards for an agency to have an Rx interface for push-to-talk applications and a separate Rx interface for video for the same user equipment. Additionally, there is no interface defined in the standards, similar to the Rx interface, to allow user-based policy and charging related information to be provided by an application for MBMS resources and point-to-multipoint broadcast sessions.

Accordingly, there is a need for a method and apparatus for consistently applying user-based priority and quality of service (QoS) policy to all sessions and applications on each device associated with a given user.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIGS. 1A and 1B are block diagrams of a broadband system used in accordance with some embodiments.

FIG. 2 is a block diagram of how user priority is determined in accordance with some embodiments.

FIGS. 3A and 3B depict a flow diagram of how priority and Quality of Service (QoS) policy is determined in accordance with some embodiments.

FIG. 4 is another block diagram of the broadband system used in accordance with some embodiments.

FIG. 5 is an example of internal functional blocks of a user device used in accordance with some embodiment.

FIG. 6 is an example of internal functional blocks of a network device used in accordance with some embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Some embodiments are directed to methods and apparatuses for consistently applying user-based priority and quality of service (QoS) policy to sessions and applications on each device associated with a given user. A network component in a broadband network receives dynamic status information associated with a user accessing the broadband network with a first user equipment. The network component also retrieves stored priority attributes associated with the user and identifies whether another user equipment is associated with the user. The network component determines unicast and Multimedia Broadcast Multicast Service (MBMS) access network policy for all user equipment associated with the user by using the dynamic status information and the stored priority attributes. The network component associates the access network policy with each user equipment associated with the user and forwards the access network policy to a policy component. The access network policy is used in determining priority and quality of service policy for each user equipment associated with the user.

FIGS. 1A and 1B are block diagrams of a broadband system 100 used in accordance with some embodiments. System 100 includes an overall public safety broadband network 102 (also referred to as a Long Term Evolution (LTE) network 102), regional network operation centers (NOCs) 104 (that is, NOCs 104a-104x), user equipment 106 used by public safety agencies (referred to as public safety user devices 106), user equipment 108 used by secondary users/subscribers (referred to as secondary user devices 108), and user equipment 109 used by casual users/subscribers (referred to as casual user devices 109). Public safety user devices 106 (that is, public safety user devices 106a-106x), secondary user devices 108 (that is, secondary user devices 108a-108x) and/or casual user devices 109 (that is, casual user devices 109a-109x) may be, for example, cell phones, laptops, video monitors, computer-aided dispatch (CAD) systems, mobile or portable user terminals, such as mobile telephones, portable radios or radios on vehicles (herein collectively referred to as “devices 106, 108, and/or 109”).

LTE network 102 may be administered by, for example, a national carrier that covers a large geographic area, for example, multiple states. LTE network 102 includes, among other network components, a Home Subscriber Server (HSS) 110, and Policy and Charging Rules Function (PCRF) Server 112 (simply referred to as PCRF 112). HSS 110 includes subscription-related information (subscriber profiles for users of devices 106, 108, and 109), and can provide information about the subscriber's location. PCRF 112 is responsible for policy control decision-making and sends quality of service (QoS) setting information for each of devices 106, 108 and 109 using LTE network 102. PCRF 112 may include a component (not shown) associated with an LTE multimedia broadcast/multicast service.

Each NOC 104 (that is, each of NOCs 104a-104x) provides coverage for a geographic area that is smaller than the geographic area covered by LTE network 102. For example, each NOC 104 may provide coverage for a state covered by LTE network 102. Each NOC 104 includes a Packet Data Network Gateway (PGW) 114, a public safety middleware (PSM) 116 and components of an IP Multimedia Subsystem (IMS) 118. When each of devices 106, 108, and 109 registers with LTE network 102, one of NOCs 104a-104x associated with a registering device authenticates the registering device and the associated subscriber. While devices 106, 108, and 109 are accessing LTE network 102, the associated NOC 104 also keeps track of active applications and access point names (APNs) associated with a given user across all devices, keeps track of all devices 106, 108, and 109 associated with the given user, and keeps track of the locations (cell/sector) of devices 106, 108, and 109 on LTE network 102.

PGW 114 in each of NOCs 104a-104x is responsible for IP address allocation for devices 106, 108, and 109 operating on LTE network 102 and for QoS enforcement in accordance with QoS setting information received from PCRF 112 on a Gx interface. PGW 114 in each of NOCs 104a-104x also processes user data sent from devices 106, 108, and 109. In some embodiments, each of NOCs 104a-104x may maintain at least one database 120 that stores user and agency priority attributes (referred to herein as default priority attributes).

PSM 116 in each of NOCs 104a-104x is a network component (i.e., a network processing device) configured to receive dynamic priority attributes for devices 106, 108, and 109 from external sources, including devices 106, 108, and 109. Each PSM 116 may combine the stored user and agency priority attributes associated with a given user with the dynamic priority attributes received from external sources to determine the access network policy for each device associated with the given user. Each PSM 116 then maps the determined access network policy to all applications and IP flows on each device 106, 108, and/or 109 associated with the given user. Each PSM 116 sends the access network policy for each device 106, 108, and/or 109 to PCRF 112 or a multimedia/broadcast multicast function (not shown). PCRF 112 or the multimedia/broadcast multicast function uses the access network policy to provide priority and QoS unicast and MBMS policy for each device 106, 108, and/109 associated with the given user. This ensures that PCRF 112 or the multimedia/broadcast multicast function can consistently apply priority and QoS policies to devices 106, 108, and 109 and to device flows, regardless of which IP-CAN session (APN) each of devices 106, 108, and 109 is using.

Components of IMS 118 in each of NOCs 104a-104x is used to deliver IP multimedia services. Each IMS 118 communicates with LTE network 102 by sending information to LTE network 102 through an associated PSM 116 in NOCs 104a-104x. To prevent policy requests from bypassing the PSM, the PSM 116 in each of NOCs 104a-104x serves as an Rx proxy. This ensures that each PSM 116 can apply the access network policy to applications sent from components of an associated IMS 118 in NOCs 104a-104x. Each PSM 116 may use a standard LTE Rx (unicast) interface or a policy control interface for the multicast/broadcast service to transmit the access network policy to PCRF 112 or the multimedia/broadcast multicast function in LTE Network 102. The reader will appreciate that the PSM may be utilized as an Rx proxy for any application function, and is not strictly limited to the IMS 118.

Public safety user devices 106a-106x may be used by subscribers/users in a public safety agency, for example, a police or fire department. Secondary user devices 108a-108x may be used by subscribers/users in, for example, a government entity, such as, a local school district or a county employee, or a utility. Casual user devices 109a-109x may be used by, for example, a commercial subscribers/users or unknown subscribers (i.e., casual user devices 109a-109x may be registered with LTE network 102, but are not associated with a specific user). Each of devices 106, 108, and/or 109 associated with a single subscriber may use the same or different broadband networks. For example, a first responder may use public safety user device 106a (which may be, for example, a smart phone) on a third generation (3G) network and another public safety user device 106i (which may be, for example, a laptop) on a fourth generation (4G) network. A single subscriber may also use one or more of devices 106, 108, and/or 109 at the same time across one or more IP networks. For example, the first responder may use multiple public safety user devices 106 (for example, a smart phone and a laptop) at the same time across one or more IP networks (for example, a regional IP network and a local IP network). Each of public safety user devices 106, secondary user devices 108 and/or casual user devices 109 includes a PSM client 122 that is used to communicate with a PSM in a NOC 104 with which the device is registered.

In order to avoid having to independently determine the priority and QoS policy for each device 106, 108, and 109 using the shared public safety spectrum while coordinating the priority and QoS policy for multiple devices associated with a given subscriber (for example, the first responder), each PSM 116 combines different types of priority attributes to generate the access network policy. In an embodiment, when any one of devices 106, 108, and 109 is accessing LTE network 102, the devices provide dynamic status information, including location information, to a PSM 116 via its PSM client 122.

Consider an example where the first responder is using public safety user device 106a which may be, for example, a portable phone. When the first responder activates an emergency button on the portable phone, the portable phone transmits information via its PSM client 122 to indicate that the emergency button has been activated. Similarly, when the first responder deactivates the emergency button, the portable phone transmits information to indicate that the emergency button has been deactivated. In another example, if the first responder is in immediate peril (witnesses an incident that is about to occur) and activates an immediate peril button on another public safety user device 106, for example, a mobile radio, the mobile radio with the activated immediate peril button transmits, via its PSM client 122, information to indicate that the immediate peril button has been activated. Similarly, when the first responder deactivates the immediate peril button, the mobile radio transmits, via its PSM client, information to indicate that the immediate peril button has been deactivated. In another example, when the first responder is dispatched to an incident, the responder may activate a button on one or more public safety user devices 106 (for example, the mobile radio and/or a laptop) and each of the mobile radio and/or laptop transmits, via its PSM client 122, an incident indication. PSM 116 is configured to assign a priority to the first responder based on the incident type associated with the incident button(s) activated by the responder.

Each PSM 116 may combine the dynamic priority attributes obtained from a variety of external sources, including devices 106, 108, and/or 109 and applications, such as a CAD terminal, with the stored/default priority attributes associated with a given user of devices 106, 108, and/or 109 to create the access network policy that is used in generating priority and QoS policy for each application and IP connectivity session on each device associated with the given user. For example, PSM 116 in each of NOCs 104a-104x may retrieve the default priority attributes from the local database 120 in the associated NOC or from another source. The default priority attributes may be, for example, an application class, a user class, and/or a jurisdiction status. The application class, user class, and/or jurisdiction status are non-limiting examples of the default priority attributes that may be used by PSM 116a.

When the application class is used as one of the default priority attributes associated with the subscriber, different priority levels may be assigned to different classes of application. For example, mission critical voice application may be assigned a first priority, missing critical data applications may be assigned a second priority, non-mission critical voice application may be assigned a third priority, video and multimedia applications may be assigned a fourth priority, and other applications, such a text, internet traffic, or file transfers may be assigned a fifth priority. Using this example, a push-to-talk application may be assigned a higher priority than a video application. When the user class is used as one of the default priority attributes, different priority levels may also be assigned to different classes of users. For example, a primary subscriber, such as first responders (i.e., users of public safety user devices 106), may be assigned a first priority, secondary users, such as utility and government workers (i.e., users of secondary user devices 108), may be assigned a second priority, commercial users (i.e., users of casual user devices 109) may be assigned a third priority, and unknown users (i.e., those users not registered with the LTE network and users of casual user devices 109) may be assigned a fourth priority.

Different priority levels may also be assigned based on the jurisdictional status. For example, a default priority may be assigned based on whether or not a subscriber is within an assigned jurisdictional boundary. A subscriber within an assigned jurisdiction may be assigned a first priority, a subscriber outside of the assigned jurisdiction but responding to an incident (for example, fire, medical emergency) may be assigned a second priority, a subscriber outside of the assigned jurisdiction and not responding to an incident may be assigned a third priority, an unknown subscriber may be assigned a fourth priority. Consider an example were the first responder is traveling in a vehicle with a mobile phone and one or more cameras. When the vehicle travels outside of the first responder's home jurisdictional boundary, for example, to go to court, the devices on the vehicle may inadvertently be turned on and may be consuming network resources. In this situation, the priority assigned to the first responder may be lower than the priority assigned to another first responder who is in his home jurisdictional boundary.

Each PSM 116 combines the default priority attributes and the dynamic priority attributes received from external sources, including devices 106, 108, and/or 109, to generate the access network policy for a given user. The PSM 116 associates the access network policy with all applications and IP connectivity sessions on all devices 106, 108, and/or 109 associated with the given user. The PSM 116 forwards the access network policy for each device 106, 108, and/or 109 associated with the given user to PCRF 112 or the multimedia/broadcast multicast function. The access network policy may include, but is not limited to, one or more attributes that have an impact on the access network characteristics, such as, the ability to influence how a user equipment communicates with the access network, the ability to influence the admission of a new flow, the ability to influence whether or not a flow can be pre-empted, and/or the ability to influence the quality of experience after a flow has been admitted (e.g., influencing packet loss rate, packet latency). The PSM 116 may forward Allocation and Retention Priority (ARP), an admission priority, QoS Class Identifier (QCI), Maximum Bit Rate (MBR), Guaranteed Bit Rate (GBR) for unicast and multicast/broadcast to PCRF 112 or the multimedia/broadcast multicast function. The PSM 116 may also identify the access class to be downloaded to device 106, 108, or 109. The access class indicates which device is given an elevated priority for accessing LTE network 102 when the network resources are overloaded in, for example, an emergency. The PSM 116 may also send information about IP-CAN sessions that should started, maintained, or deleted. The PSM 116 may also provide an indication(s) of application(s) that are authorized for use per APN given a set of priority variables. The PSM 116 may also provide indication(s) of application(s) that should be activated or terminated. The PSM 116 may also provide an indication of the quality of experience, a scheduling priority, a packet loss rate, a packet latency, and/or an indication of whether or not a given flow or bearer may be pre-empted. The PSM 116 may also provide indication(s) of PSM interface(s) that are authorized for use by each of devices 106, 108, and/or 109. PCRF 112 or the multimedia/broadcast multicast function uses the access network policy to apply priority and QoS policy to each device 106, 108, and/or 109 and/or application associated a user.

FIG. 2 is a block diagram of how user priority is determined in accordance with some embodiments. A user 202 may be associated with one or more user equipments 204 (that is, user equipment 204a-204x) (which is also shown as device 106, 108, and/or 109 in FIG. 1). When, for example, user equipment 204a logs on to the system, the LTE network registers user 202 associated with user equipment 204a, user equipment 204a, and the location of user equipment 204a. The PSM obtains stored/default priority attributes 206, for example, one or more of the application class, the user class and the jurisdictional coordinates from a database. The stored/default priority attributes 206 are associated with user 202 as shown by the connection between attributes 206 and user 202. The stored/default priority attributes 206 noted herein are non-limiting and are provided only as examples of stored/default priority attributes that may be used. The PSM also obtains dynamic priority attributes 208, for example, an emergency indication, an immediate peril indication, and/or an incident indication, sent from the user equipment 204a. The PSM may also obtain other dynamic priority attribute from one or more external sources. The dynamic priority attributes noted herein are non-limiting examples. The PSM uses stored/default priority attributes 206 and dynamic priority attributes 208 in determining the access network policy and maps the access network policy to each device 204a-204x associated with user 202. The PSM sends the access network policy for each device 204 associated with user 202 to the PCRF or the multimedia/broadcast multicast function. The PCRF or the multimedia/broadcast multicast function then determines priority and QoS policy, not only for user equipment 204a, but all also user equipment 204 associated with user 202.

FIGS. 3A and 3B depict a flow diagram of how priority and QoS policy is determined in accordance with some embodiments. At 302, a system administrator in, for example, a public safety agency may enter information into a database associated with a broadband system. For example, the system administrator may add one or more of user information, application information, and/or jurisdictional coordinates/definitions. The system administrator may also add other information into the database. Using this example, the administrator may add a first responder and identify the first responder as a primary user. The system administrator may also add information about an application and may define the application class and other flow attributes to be associated with the application. The system administrator may further provide geographic coordinates of a home jurisdictional area for the first responder.

At 304, a first public safety user device (also shown, for example, as device 106a in FIG. 1A and FIG. 1B) being used by the first responder registers with the PSM, for example, the PSM 116 in NOC 104a, and the PSM stores an identifier for the first responder, an identifier for the first public safety user device, and the location of the first public safety user device. This will enable the PSM to keep track of the devices being used by the first responder, the IP-CAN session(s) associated with each device and the service data flows associated with each IP-CAN session. At 306, the PSM obtains stored/default priority attributes, for example, an application class, a user class and jurisdictional status (i.e., the jurisdictional coordinates) from the database, for example, the database 120 in NOC 104a. At 308, the PSM obtains the dynamic priority attributes, for example, an emergency indication, an immediate peril indication, or an incident indication, from the first public safety user device. At 310, for each IP-CAN session for the first public safety user device, the PSM determines the access network policy and sends the access network policy to the PCRF for the first public safety user device. The PSM may also send the access network policy to the multimedia/broadcast multicast function for the first public safety user device. Based on the access network policy, in-progress resources and policies may be altered and new bearers may be activated. At 312, the PSM may update the access class for the first public safety user device.

At 314, a second public safety user device (for example, public safety user device 106i) being used by the first responder registers with the PSM, the PSM stores an identifier for the first responder, an identifier for the second public safety user device, and the location of the second public safety user device. The PSM obtains the default priority attributes associated with first responder and the dynamic priority attributes associated with the second public safety user device, determines the access network policy, sends the access network policy to the PCRF, for example, the PCRF 112, for the first and second public safety user devices, and may update the access class for the second public safety user device. The PSM may also send the access network policy to the multimedia/broadcast multicast function for the first and second public safety user devices. Note that based on the default priority attributes associated with first responder and the dynamic priority attributes associated with the second public safety user device, the PSM updates the access network policy associated with the first public safety user device. At 316, the PCRF uses the access network policy in generating priority and QoS policy for applications and IP connectivity sessions associated with each of the first and second public safety user devices. At 318, depending on the status of the first responder, the PSM may receive subsequent dynamic priority attributes from one of the first public safety user device, the second public safety user device, or an external entity. For example, the PSM may receive an indication from the first public safety user device when the first responder accesses an application; or the PSM may receive an indication from the second public safety user device when the second public safety user device is in a specific jurisdiction; or the PSM may receive an indication from the first public safety user device when an emergency button is activated on the first public safety user device; or the PSM may receive an indication from the second public safety user device when a button associated with a high priority incident is activated; or the PSM may receive an indication from the first public safety user device when it is powered off; or the PSM may receive an information from a CAD system for one or more of the first and second public safety user devices.

At 320, the PSM re-evaluates the access network policy for each of the first and second public safety user devices based on the default priority attributes associated with the first responder and the updated dynamic priority attributes received from the first and/or second public safety user devices. At 322, the PSM sends the access network policy to the PCRF for each of the first and second public safety user devices and for other applications associated with the first responder. The PSM may also send the access network policy to the multimedia/broadcast multicast function for the first and second public safety user devices and for other applications associated with the first responder. At 324, the PCRF uses the access network policy in generating priority and QoS policy for each of the first and second public safety user devices and for other applications associated with the first responder.

FIG. 4 is another block diagram of a broadband system 400 used in accordance with some embodiments. System 400 includes a LTE network 102, which includes, among other components, HSS 110, PGW 114, PCRF 112 which includes PSM 116, and IMS 118. PCRF 112 may also include a multimedia/broadcast multicast function (not shown). System 400 may also include one or more public safety agencies 424 which may include public safety user devices 406, that is, a video system 406a, a CAD system 406b and a laptop 406c. Each of video system 406a and laptop 406c are associated with a single user. CAD system 406b may be used by a system administrator to provide dynamic priority attributes associated with the user. The user may also use phone 406d that may not be associated with public safety agency 424.

When each of video system 406a, laptop 406c, and phone 406d registers with the LTE network 102, the PSM 116 stores an identifier for an associated first responder, an identifier for each of video system 406a, laptop 406c, and phone 406d, and the location of each of video system 406a, laptop 406c, and phone 406d. This will enable the PSM 116 to keep track of the devices being used by the first responder, the IP-CAN session(s) associated with each device and the service data flows associated with each IP-CAN session. The PSM 116 obtains the default priority attributes, for example, an application class, a user class, and a jurisdictional status for the first responder from database 120. The PSM 116 obtains the dynamic priority attributes, for example, an emergency indication, an immediate peril indication, or an incident indication, from each of video system 406a, laptop 406c, and phone 406d. The PSM 116 may also obtain dynamic priority attributes, for example, for the first responder from a system administrator utilizing the CAD system 406b. For each IP-CAN session associated with each of video system 406a, laptop 406c, and phone 406d, PSM 116 determines the access network policy and sends the access network policy for video system 406a, laptop 406c, and phone 406d to PCRF 112. The PSM may also send the access network policy to the multimedia/broadcast multicast function for each of video system 406a, laptop 406c, and phone 406d. Based on the access network policy, in-progress resources and policies may be altered and new bearers may be activated. PSM 116 may update the access class for one or more of video system 406a, laptop 406c and phone 406d.

PCRF 112 or the multimedia/broadcast multicast function may use the access network policy to generate unicast and MBMS priority and QoS policy for each of video system 406a, laptop 406c, and phone 406d and other applications associated with the first responder. PSM 116 may receive subsequent dynamic priority attributes from one of video system 406a, laptop 406c, and/or phone 406d, or an external entity. PSM 116 re-evaluates user policy information for each of video system 406a, laptop 406c, and phone 406d based on the default priority attributes associated with the first responder and the updated dynamic priority attributes received from video system 406a, laptop 406c, and/or phone 406d. The PCRF 112 or the multimedia/broadcast multicast function may use the updated access network policy received from PSM 116 to generate updated priority and QoS policy for each of video system 406a, laptop 406c and phone 406d and other applications associated with the first responder.

FIG. 5 is an example internal functional blocks of a user device 500 used in accordance with some embodiments. Device 500 is similar to devices 106, 108 and/or 109 of FIG. 1, user equipments 204 of FIG. 2, and user devices 406 of FIG. 4. As shown in FIG. 5, device 500 includes a communications unit 502 coupled to a common data and address bus 517 of a processing unit 503. The device 500 may also include an input unit (e.g., keypad, pointing device, etc.) 506, an output transducer unit (e.g., speaker) 520, an input transducer unit (e.g., a microphone) 521, and a display screen 505, each coupled to be in communication with the processing unit 503.

The processing unit 503 may include an encoder/decoder 511 with an associated code ROM 512 for storing data for encoding and decoding voice, data, control, or other signals that may be transmitted or received between base station or other user equipment. The processing unit 503 may further include a microprocessor 513 coupled, by the common data and address bus 517, to the encoder/decoder 511, a character ROM 514, a RAM 504, and a static memory 516. The processing unit 503 may also include a digital signal processor (DSP) 519, coupled to the speaker 520, the microphone 521, and the common data and address bus 517, for operating on audio signals received from one or more of the communications unit 502, the static memory 516, and the microphone 521.

The communications unit 502 may include an RF interface 509 configurable to communicate with other subscriber devices within its communication range and with base stations and/or NOCs within its communication range. The communications unit 502 may include one or more broadband wireless transceivers 508, such as an LTE transceiver, a 3G (3GGP or 3GGP2) transceiver, a WiMAX transceiver perhaps operating in accordance with an IEEE 802.16 standard, and/or other similar type of wireless transceiver configurable to communicate via a wireless network, for infrastructure communications. Additionally or alternatively, communication unit 502 may include one or more second narrowband radio transceivers such as an APCO P25 transceiver, a DMR transceiver, a TETRA transceiver, or one or more second local area network or personal area network transceivers such as Wi-Fi transceiver perhaps operating in accordance with an IEEE 802.11 standard (e.g., 802.11a, 802.11b, 802.11g) or a Bluetooth transceiver, for subscriber device to subscriber device communications. The transceiver 508 is also coupled to a combined modulator/demodulator 510 that is coupled to the encoder/decoder 511. The character ROM 514 stores code for decoding or encoding data such as control, request, or instruction messages, channel change messages, and/or data or voice messages that may be transmitted or received by device 500.

Static memory 516 may store operating code 525 associated with a PSM client that when executed on the microprocessor 513, causes device 500 to, responsive to detecting a status change, such as an activated button: transmit dynamic priority attributes via a transmitter to the PSM in the LTE network, in accordance with one or more steps as set forth in FIG. 3 and the corresponding text. Static memory 516 may comprise, for example, a hard-disk drive (HDD), an optical disk drives such as a compact disk (CD) drive or digital versatile disk (DVD) drive, a solid state drive (SSD), a tape drive, a flash memory drive, or a tape drive, to name a few.

FIG. 6 is an example internal functional blocks of a network device 600 used in accordance with some embodiment. Device 600 is similar to PSM 116 of FIG. 1 and includes a receiving component 602, a processing component 604 and a transmitting component 606. Receiving component 602 is configured to receive dynamic status information associated with a user accessing a broadband network with a first user equipment. Receiving component 602 may include one or more interfaces (not shown) configurable to communicate with one or more user devices (for example, devices 106, 108, and/or 109 of FIG. 1 or 406a-406d of FIG. 4) and network components (for example, IMS 118 and PCRF 112 of FIG. 1 and FIG. 4) within its communication range. For example, receiving component 602 may receive the dynamic status information on an Rx interface from, for example, from IMS 118, or on an application programming interface (API) from, for example, PSM client 122 of FIG. 1 and FIG. 4.

Processing component 604 may include an associated code ROM (not shown) for storing data or other signals that may be transmitted to or received from other network components and the user equipments. Processing component 604 may further include a microprocessor (not shown) that is configured to retrieve stored priority attributes associated with the user of the first user equipment, identify other user equipment associated with the user of the first user equipment, determine the access network policy for all user equipments associated with the user by using the dynamic status information and the stored priority attributes, and associate the access network policy with each user equipment associated with the user.

Transmitting component 606 may include one or more interfaces (not shown) configurable to communicate with one or more user equipments and network components within its communication range. Transmitting component 606 is configured to transmit the access network policy to a policy component in the broadband network for each user equipment associated with the user, wherein the access network policy is used in determining priority and quality of service policy for each user equipment associated with the user. In some embodiments, the policy component may be in device 600.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method comprising:
receiving, by a network component in a broadband network, dynamic status information associated with a user accessing the broadband network using a first user equipment;
retrieving, by the network component, stored priority attributes associated with the user and identifying whether another user equipment is associated the user;
determining, by the network component, access network policy for all user equipment associated with the user by using the dynamic status information and the stored priority attributes;
associating, by the network component, the access network policy with each user equipment associated with the user; and
forwarding, by the network component, the access network policy to a policy component, wherein the access network policy is used in determining priority and quality of service policy for each user equipment associated with the user.

2. The method of claim 1, wherein the access network policy is associated with each connectivity session between all user equipment associated with the user and the broadband network; and
wherein the access network policy includes one of unicast access network policy and multimedia broadcast or multicast access network policy.

3. The method of claim 1, wherein the dynamic status information includes at least one of location information, an emergency indication, an immediate peril indication, and an incident indication.

4. The method of claim 3, wherein the priority and quality of service policy is based on an incident type associated with the incident indication and the priority and quality of service policy is based on an updated jurisdictional status associated with the location information.

5. The method of claim 1, wherein the stored priority attributes include at least one of an application class, a user class, and jurisdictional coordinates.

6. The method of claim 5, wherein when the stored priority attributes include the application class, different priority levels are assigned to different classes of applications, and when the stored priority attributes includes the user class, different priority levels are assigned to different classes of users.

7. The method of claim 5, wherein when the stored priority attributes include the jurisdictional coordinates, different priority levels are assigned based on when the first user equipment is within a jurisdictional boundary or outside of the jurisdictional boundary and whether or not the first equipment is assigned to an incident when outside of the jurisdictional boundary.

8. The method of claim 1, wherein the receiving comprises receiving the dynamic status information from at least one of the first user equipment or another source.

9. The method of claim 1, wherein the access network policy includes at least one of: an allocation and retention priority, an admission priority, a quality of service class identifier, a maximum bit rate, a guaranteed bit rate, an access class to be downloaded to the first user equipment, information about connectivity sessions that should started, maintained, or deleted, indications of applications that are authorized for use per connectivity session given a set of priority variables, indications of applications that should be activated or terminated, an indication of a quality of experience, a scheduling priority, a packet loss rate, a packet latency, an indication of whether or not a given flow or bearer may be pre-empted, and indications of interfaces that are authorized for use by each user equipment associated with the user.

10. The method of claim 1, further comprising storing, by the network component, an identifier for the user, an identifier for the first user equipment and a location of the first user equipment subsequent to receiving the dynamic status information associated with the first user equipment.

11. The method of claim 1, further comprising at least one of:
altering current resource allocations and policies; and
activating new bearers based on the access network policy.

12. The method of claim 1, wherein the receiving comprises receiving the dynamic status information from one of a Long Term Evolution (LTE) Rx interface or an application programming interface.

13. The method of claim 1, wherein the policy component comprises a component associated with an LTE multimedia broadcast/multicast service.

14. The method of claim 1, wherein each user equipment associated with the user is configured to utilize a different broadband network.

15. The method of claim 1, wherein each user equipment associated with the user is configured to utilize the same broadband network.

16. The method of claim 1, wherein the determining, by the network component, comprises determining the access network policy for multiple applications using multiple access point names on a single user equipment.

17. A broadband network apparatus comprising:
a receiving component configured to receive dynamic status information associated with a user accessing a broadband network with a first user equipment;
a processing component configured to retrieve stored priority attributes associated with the user, determine whether another user equipment is associated with the user, determine an access network policy for all user equipment associated with the user by using the dynamic status information and the stored priority attributes, and associate the access network policy with each user equipment associated with the user; and
a transmitting component configured to transmit the access network policy to a policy component in the broadband network for each user equipment associated with the user, wherein the access network policy is used in determining priority and quality of service policy for each user equipment associated with the user.

18. A method comprising:
receiving, by a network component in a broadband network, dynamic status information associated with a user accessing the broadband network using a first user equipment;
retrieving, by the network component, stored priority attributes associated with the user and identifying whether another user equipment is associated the user;
determining, by the network component, access network policy for all user equipment associated with the user by using the dynamic status information and the stored priority attributes;
associating, by the network component, the access network policy with each user equipment associated with the user; and
determining, by the network component based on the access network policy, priority and quality of service policy for each user equipment associated with the user.

19. The method of claim 18, wherein the access network policy is associated with each connectivity session between all user equipment associated with the user and the broadband network; and wherein the access network policy includes one of unicast access network policy and multimedia broadcast or multicast access network policy.

20. The method of claim 18, wherein the network component comprises a component associated with an LTE multimedia broadcast/multicast service.
